(19) United States
(12) Patent Application Publication
(10) Pub. No.: US 2024/0338736 A1
(43) Pub. Date: Oct. 10, 2024

(54) SYSTEM AND METHOD FOR MANAGING CUSTOMER FEEDBACK

(71) Applicant: Ornis Mala, Frisco, TX (US)

(72) Inventor: Ornis Mala, Frisco, TX (US)

(73) Assignee: KORE. CO, Frisco, TX (US)

(21) Appl. No.: 18/419,723

(22) Filed: Jan. 23, 2024

Related U.S. Application Data
(60) Provisional application No. 63/457,338, filed on Apr. 5, 2023.
(60) Provisional application No. 63/472,364, filed on Jun. 12, 2023.

(51) Int. Cl. G06Q 30/0282

(52) U.S. Cl. CPC G06Q 30/0282

(57) ABSTRACT

Systems and methods are provided herein for managing online reviews. A platform tool is provided that allows clients to create accounts and their customers to review their goods and/or services. This tool organizes, collects, manages and promotes online reviews. The system includes a client accreditation process to monitor online reputation, an artificial intelligence driven automatic responder to trigger a response to received reviews without human intervention, and a review page management feature to allow the client a second chance to address any potential negative review is posted.

### CROSS-REFERENCE TO RELATED APPLICATION

This application claims priority to U.S. Provisional Application Ser. No. 63/457,338, filed Apr. 5, 2023, entitled SYSTEM FOR MANAGING CUSTOMER FEEDBACK and U.S. Provisional Application Ser. No. 63/472,364, filed Jun. 12, 2023, entitled AUTOPILOT AI RESPONSE FOR SYSTEM FOR MANAGING CUSTOMER FEEDBACK, both of which are hereby incorporated by reference in their entirety.

### BACKGROUND OF THE INVENTION

### I. Field of the Invention

The present disclosure relates generally to managing customer feedback, and more specifically to a system and method for gathering and managing customers reviews of products and/or services and tracking, analyzing, and generating reports therefrom.

### II. Description of the Prior Art

An online review is a statement concerning the quality of a product or service that has been published on the internet. These statements typically appear on a subject company website and/or third-party websites dedicated to reviews (e.g., Google, Yelp, TripAdvisor, etc.). When potential customers read online reviews, it has an impact on whether they decide to purchase. Good reviews beget good business and bad reviews beget bad business. In today's world, reviews can make or break a business. As such, customer reviews drive business.

Accordingly, it is appreciated that positive reviews may be the single most effective marketing a company has in its quiver. Companies want positive reviews and do not want negative reviews. While the value of customer reviews for a business is well documented, the desire to feature only positive comments on review sites is getting some businesses in serious legal trouble. By way of example, a business may try to control or otherwise influence the public reviews that are posted online about their business in an attempt to boost their perception and hide negative comments. This process, known as review gating, damages consumer trust and not only is contrary to most review sites' terms of service, it's legal consequences can be severe. Indeed, considering some nefarious business practices by companies attempting to suppress and/or delete negative reviews, the US Congress passed the Consumer Review Fairness Act (CRFA). The CRFA essentially prohibits use of contracts that ban or restrict reviews, impose a penalty or other fee, or give up intellectual property in their reviews. Furthermore, the Federal Trade Commission now prohibits company suppression of negative reviews—the aforementioned gating.

Business owners cannot afford to ignore reviews as they are now an integral part of business. Responding to reviews are therefor paramount. Responding positively to negative reviews can turn them positive and responding positive to positive reviews can ensure customer happiness and further business growth. Accordingly, there is a need for effective review management.

Review management is the process of monitoring reviews left online across various websites. In other words, it is the active analysis and regulation of product and/or service reviews left online. This is done to enable the business to execute review response strategy, resolve customer issues as they arise, and quickly remove fake reviews before they cause issues.

Effective review management typically includes an apparatus that cycles through four steps. Namely, collecting existing reviews; analyzing those reviews; prompting new reviews; and monitoring results of management. It is almost impossible, in today's world, to not have an online presence for one's business. One's online reputation consists of the sum of all the online customer reviews that exist across all available review sites and social platforms. This collection of reviews is most critical to the management process as missing any major input will skew any results. The bigger the input source missed, the bigger misrepresentation and the farther off any analysis and subsequent strategy will be.

The traditional text and sentiment analysis techniques may be used to analyze the dataset gathered. When done correctly, this will result in actionable insights of customer satisfaction, common difficulties, and overall needs. There are numerous software solutions that make sifting through all the reviews more easy. These too have remained antiquated and in need of upgrading/updating through various artificial intelligence (AI) techniques and otherwise.

In any event, after analysis, the new reviews process includes those that are then typically showcased or prompted. Showcasing is a so-called catch-and-sort method that ensures that the most positive, accurate reviews are seen first. These are those types of reviews that are received without reaching out and that best reflect the product/service, that are then featured on the business' landing page or other place to make sure that are the first thing the customer sees. Prompting, on the other hand, is a more active approach, but it does require a more accurate understanding customer satisfaction. With that understanding, the right customers can be prompted and/or incentivized to leave a review.

Monitoring needs to be treated more like a modus operandi than a step in the process of review management. Active, real-time monitoring reviews is best accomplished through software suites. Such software needs to help with crisis management by detecting and eliminating fake reviews, and flagging negative reviews so those customers can be attended to and the business image protected.

Although the currently available software does aid business owners in their customer feedback management, it again remains rather antiquated and falls short of truly growing business. The present disclosure fills this need and grows business through management and promotion of meaningful experiences with customers to drive results.

Accordingly, it is a general object of the present disclosure to provide a more effective system and method for managing customer feedback.

It is another general object of this disclosure to provide an all-inclusive system and method that collects and manages online reviews.

It is a more specific object of the present disclosure to provide a system and method for providing business owners with the opportunity to address customer issues before negative reviews are submitted.

It is another more specific object of the present disclosure to provide a system and method that greatly reduces negative reviews, increases overall reviews and accordingly increases average ratings of reviews.

It is yet another more specific object of the present disclosure to provide a system and method that utilizes AI to respond to customer issues.

Yet a further object of the present disclosure is to provide a system and method that monitors online reputation through a business accreditation process.

These and other objects, features and advantages of this disclosure will be clearly understood through a consideration of the following detailed description.

### SUMMARY OF THE INVENTION

According to an embodiment of the present disclosure, there is provided a system for managing online customer reviews including a system server, at least on client PCD and at least one customer PCD communicatively coupled to the server through a network. A system tool managing online reviews from a customer of a client and displaying review options and a non-review option.

There is also provided a method for managing online customer reviews including creating a client account, providing a customer of that account access to a system review page, and displaying options on the page of reviews and non-reviews.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified network and communication overview of the system and method for managing customer feedback of the present disclosure.

FIG. 2 is a simplified logic diagram of the client sign-up and authentication on the platform of the system and method for managing customer feedback of the present disclosure.

FIG. 3 is an exemplary client platform landing page of the system and method for managing customer feedback of the present disclosure.

FIG. 4 is a simplified logic diagram of the Artificial Intelligence (AI) automatic responder of the system and method for managing customer feedback of the present disclosure.

FIG. 5 is an exemplary AI landing page from the main landing page of FIG. 3.

FIG. 6 is a is a PCD screen shot illustrating a client AI user settings of the system and method for managing customer feedback of the present disclosure.

FIG. 7 is a simplified logic diagram of the review page management of the system and method for managing customer feedback of the present disclosure.

FIG. 8 is a PCD screen shot illustrating a client customizable review page of FIG. 7.

FIG. 9 is a simplified logic diagram of the accreditation process of the system and method for managing customer feedback of the present disclosure.

FIG. 10 is a PCD screen shot illustrating an accreditation status bar progress of achievement of the system and method for managing feedback of the present disclosure.

### DESCRIPTION OF THE PREFERRED EMBODIMENTS

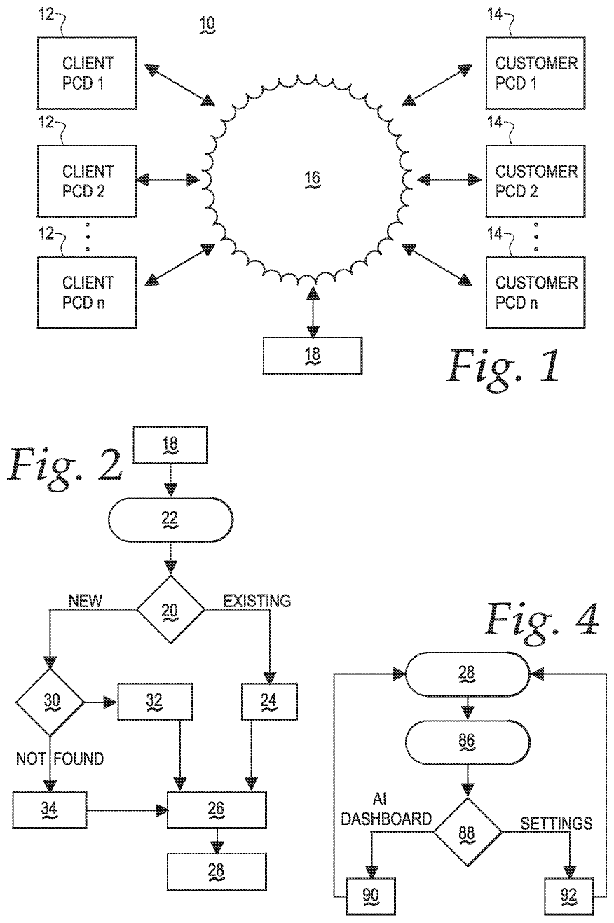

The present disclosure provides businesses with an organizational tool to collect, manage and promote reviews; as well as a review and response management service that both grows and responds to reviews. As such, the instant tool effectively increases overall reviews while also increasing the average rating of all reviews. The result is business growth through management and promotion of meaningful experiences with customers which will drive business results. One or more embodiments of the subject disclosure will now be described with the aid of numerous drawings. Turning first to FIG. 1, a simplified systems communications overview 10 is shown. In particular, clients using personal communication devices (PCD) 12 and customers using PCDs 14 communicate through a network 16 to the system main hosting server 18. Clients consist of businesses that are in need of the systems services and their PCDs consist of personal computers, laptops, smartphones and the like. Customers consist of users of client goods and/or services and their PCDs also consist of personal computers, laptops, smartphones and the like. The network consists of the internet, or otherwise, and the main hosting server is essentially connected therethrough to all clients and customers.

Clients will need to sign-up, create an account, and be authenticated before using the system and method for the first time. Such client account creation is illustrated in the logic diagram of FIG. 2. Referring thereto, the main housing server 18 is coupled to the platform host 20 (e.g., iReview.com) via remote access and application programming interfaces (APIs) 22 utilizing Google Data Warehouses, for example, which hosts all of the system data. It will be appreciated that all such applications and communications only using the highest security measures taken throughout all procedures.

Once the client reaches the iReview.com platform, the system determines whether the client is an existing client or a new client. If an existing client, they login 24, the account is authenticated 26 and the client lands on their dashboard 28. On the other hand, if a new client, Google API, for example, will search 30 for any existing online business. If an existing online business is found, all available business information is displayed and the client is prompted to confirm such information to be correct and to complete the remainder of the form 32. The new account is authenticated 26 and the client lands on their dashboard 28. Alternatively, if an existing online business is not found at all, the user is prompted to start the creation 34 of their first Google Business Page, for example. This is their first step in starting an online presence. The user is then prompted to enter all other business information, which will also be pushed to partner sites. Accordingly, a new online presence on the system local platform database as well as partner sites will be created. The new account is authenticated 26 and the client lands on their dashboard 28. Regardless of how the client eventually lands on their landing page 28 the dashboard displays, among other things, information per location, per group of locations, or all business locations, depending upon what the client has selected to be displayed.

Upon the successful creation and authentication of a client account, the system AI can then crawl the internet to gather all feedback, comments and other such client reviews and saves them to a database. With such a collection, the system can then manage and promote same, thereby increasing both the number of overall reviews, and more importantly, increase review ratings. This is done, in part, through an API autopilot that uses AI to pass reviews and system suggestions to the client. The system then builds reports, dashboards, analytics, analysis, and pros/cons within the client business.

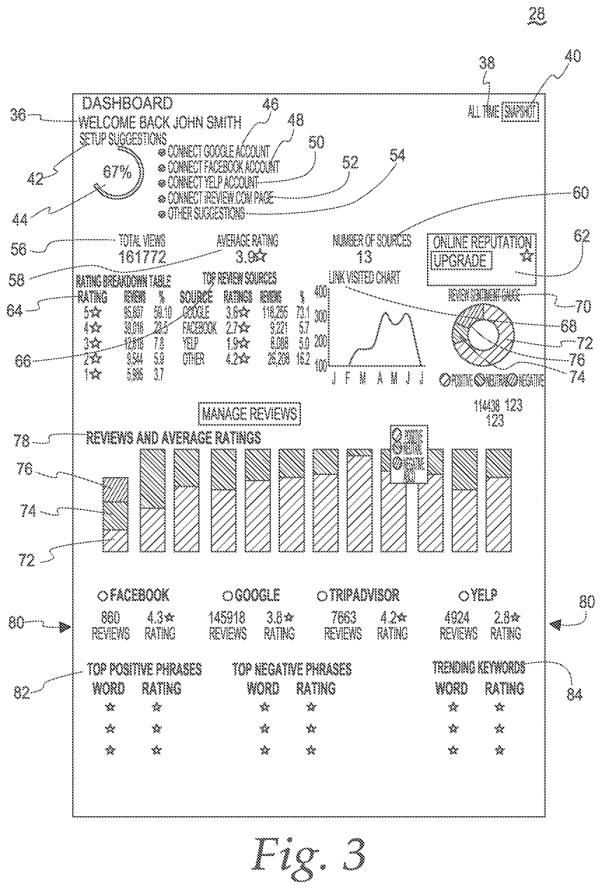

It will be appreciated that once a client account is created, the client has the opportunity to select both what kind of information is displayed and how such information is displayed on their particular dashboard. Accordingly, with such customizable layouts, displays will vary widely. As such, FIG. 3 will illustrate just a single exemplary client platform landing page. Referring now thereto, this dashboard 28 welcomes 36 the client and provides the option of displaying all-time 38 or a snapshot 40 of information. The top section of this dashboard 28 provides the client with setup suggestions 42 and an associated setup completion gauge 44. These suggestions may include, for example, connecting a Google account 46, connecting a Facebook page 48, connecting a Yelp page 50, creating an iReview.com page 52, and other such suggestions 54.

The next section of the exemplary dashboard 28 of FIG. 3 illustrates total reviews 56, average rating 58, number of sources 60 and an option to upgrade online reputation 62. This may be followed by a rating breakdown table 64, a top review sources table 66, a link visited chart 68 and a review sentiment gauge 70. This gauge typically illustrates positive reviews 72, neutral reviews 74 and negative reviews 76. The following section may illustrate a time graph of reviews and average ratings 78 wherein positive 72, neutrals 74 and negative 76 reviews are illustrated. This may be followed by source average ratings 80, top positive and negative phrases 82 and trending keywords 84, for example. It will be appreciated that the dashboard list of displayable items is too large to list herein. Similarly, further client navigation through the menu of the instant platform is also too numerous to list, and the instant disclosure will only focus on a few of these such menu items.

First, an AI automatic responder will be described. Referring to FIG. 4, a simplified logic diagram depicts client platform navigation from the dashboard 28 to the AI autoresponder 86. From the autoresponder 86, the client has the option 88 of, among other things, navigating to their AI dashboard 90, or to an AI settings page 92. The AI dashboard 90 displays all AI statistics per client business location, group of locations or all locations. It provides the client with a very useful snapshot of how the AI is performing. The AI settings page 92 enables the client to determine how the AI should respond to customer matters.

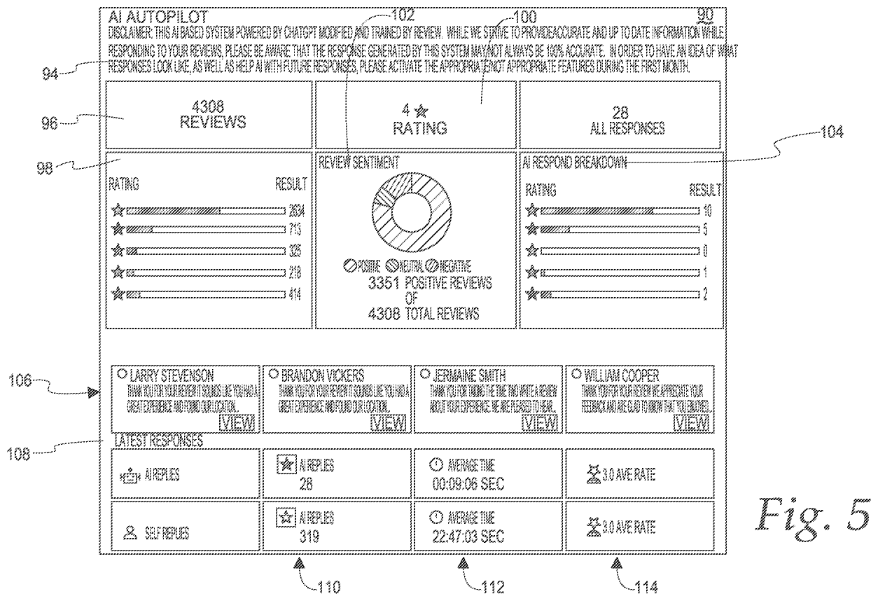

As noted with the main client dashboard 28 and FIG. 3, it will be appreciated that the client can also customize the AI dashboard 90 of FIG. 5. As such, FIG. 5 will illustrate just a single exemplary client AI autopilot landing page. Referring now thereto, this dashboard 90 welcomes 94 the client and advises of a disclaimer re the AI. In particular, the platform currently uses ChatGPT, and while exceptionally accurate, it is appreciated that such AI may not be 100% accurate. The next section illustrates a review count 96 and such review rating breakdown 98; an average rating 100 and a review sentiment gauge 102; and an AI response rating breakdown 104. The next section displays the latest AI responses 106. The bottom section illustrates AI responses vs. client self-responses 108 and includes number of responses 110, average time of responding 112 and average rating 114.

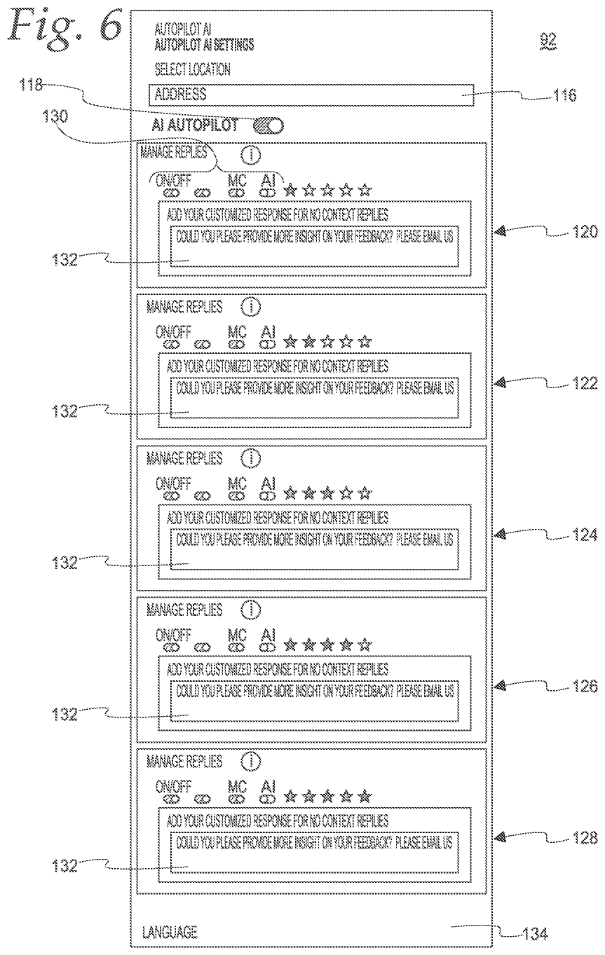

An exemplary AI settings page 92 is illustrated in FIG. 6. These settings include the settings of the AI where the client may determine how the AI should respond for each rating star (e.g., 1-5 stars) of each individual business location. Specific signatures can be added, and the AI is capable of running in multiple languages. More particularly, the client selects the business location(s) via dropdown box 116, selects 118 whether the AI autopilot is on or off for that location, and then for each rating start (one star 120, two stars 122, three stars 124, four stars 126 and five stars 128) the client selects what automation settings to include 130. It will be appreciated that the associated added response 132 is customizable depending upon the star rating. The bottom section provides the client with language selection via dropdown box 134.

As previously discussed, the system collects reviews from all sources available for each individual registered client business. API connections are then established with sources allowing such integration. Within the system is the ability to respond to these reviews using a web-based platform as well as the mobile applications. The autopilot uses an in-house trained AI, which then automatically trains the system integrated Open AI service. The system then passes the customer review, together with system suggestions including the trained specifications, to the Open AI (or any other AI source) to receive the final response of that particular review. The response is then displayed to the user on the system as well as automatically posted online. Such automatic posting can be switched to approved posting within the settings of the AI response. The autopilot feature ensures that the above-mentioned process is fully automated. As soon as a review comes through, it will trigger the internal process algorithm to execute the AI automated response. Within a few minutes (unless the client adds an additional delay in the settings), the response will be ready and posted online. Essentially, the AI autopilot provides a process of triggering an automated response to received reviews without human intervention.

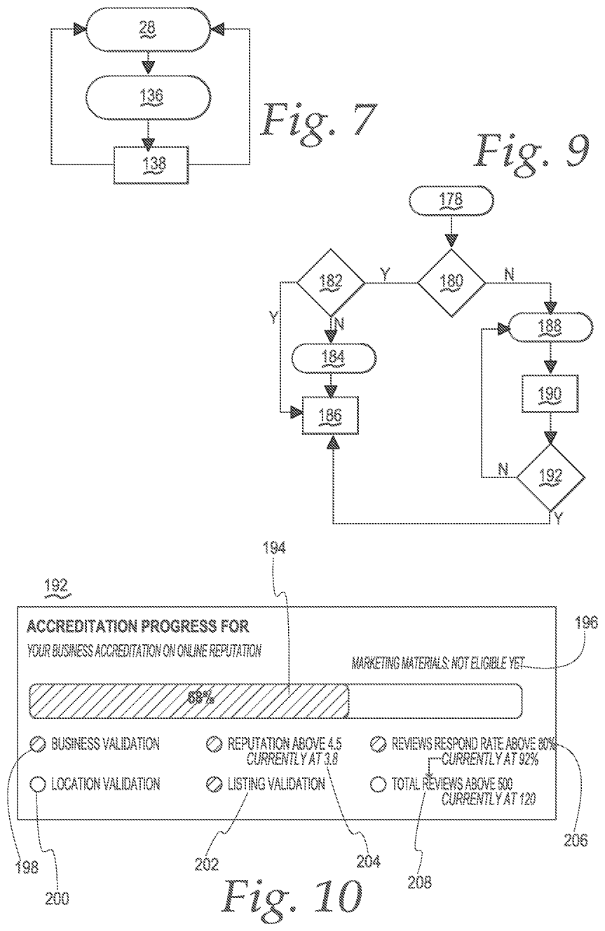

Second, a review page management will be described. Referring to FIG. 7, a simplified logic diagram of the review page management of the system and method for managing customer feedback is depicted. From the main client dashboard 28, the client navigates (under their Tools) to their review page management 136 and to the client edit option 138 to allow the client to adjust the review page. This review page is, again, fully customizable, where any of the available review sites can be added, and many options are available. A critical part of this page is the so-called Red Button-Contact Us Directly option. This does not provide the customer with the ability to review the client, but instead provides them a voice to have their concern addressed. This gives the customer a place to vent and share any of the negative experiences that they could have had within the client business, prior to that information making it online on different review sites. This gives the client a second chance to try to resolve the issue quickly and make the customer happy again.

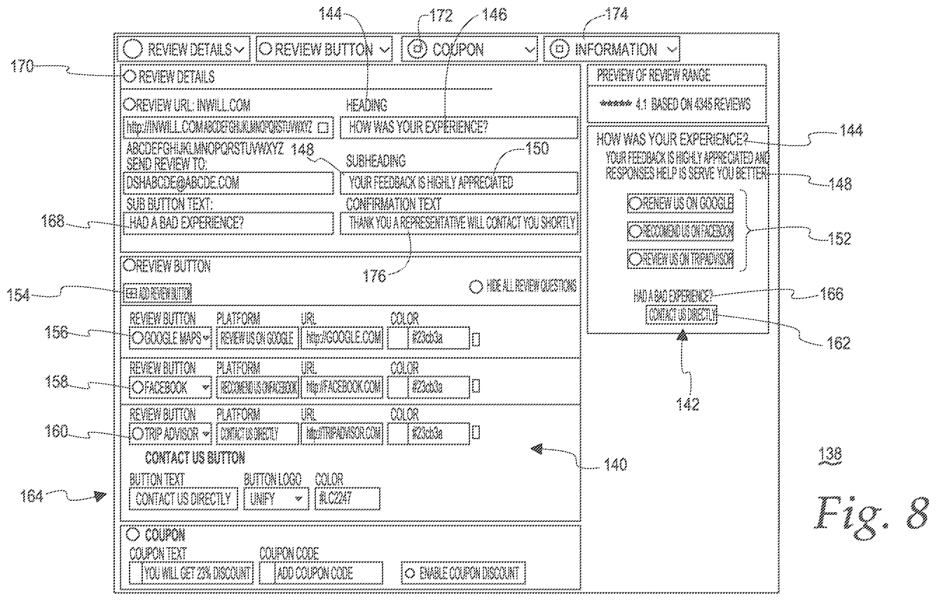

The client customizable review page 138 of FIG. 8 includes the management section 140 and the preview review page section 142. The preview review page section 142 being editable via the management section 140. In particular, the heading 144 text is entered in the provided text box 146 and the subheading 148 text is entered in the respective text box 150. The review button links 152 are editable via the dropdown options 154 of the management section 140 and may include one or more typical review sites. By way of example, the sites depicted in FIG. 8 include Google 156, Facebook 158 and Tripadvisor 160. The contact us directly button 162 is editable in the so-called Red Button section 164 of the management portion, with its header 166 editable in the dropdown box 168 of the review detail section 170. The review page 138 may further include a coupon section 172 and/or an information 174 section. Should the Red Button 162 be activated, a confirmation text (e.g., “Thank you, a representative will contact you shortly.”) is editable via dropdown box 176.

This customized tool essentially gives the business owners a chance to be able to address a problem that their customer is having, by providing a personal approach to the customer to be able to resolve the issue and make the customer happy again. The review link is accessed through QR Codes used in table stickers, window stickers, tabletops, receipts, SMS, Email, web notifications, WiFi connection, etc. So, if/when a customer wants to leave a review for a system client, they access the review link as noted and are presented with the review page 142. However they may get there, the process starts with the presentation to the user of the option to leave a review (e.g., Google, Facebook, etc.) or to contact the business directly. The Contact Us button is preferably red and has a thumbs down icon therewithin with the use of very specific keywords, such as “Contact Us Directly” and “Had a bad experience?”. Physiologically, the red color represents a bad experience, and it has been determined via thorough research, that a vast majority of unhappy customers will click the red button when they actually have a problem. The tool protects, but does not prevent, the user from getting negative reviews. In other words, while the customer is able to go directly to a Google or Facebook review and leave a negative review, the red button with the thumbs down icon drives unhappy customers to Contact Us feedback form. Once initiated, the customer provides information and is contacted ASAP by the platform team or the company representative in order to try to resolve any issues that the customer is having with the product or service. The end goal is to make the customer happy while gaining excellent customer service for the company which generally generates more foot traffic and revenue.

Essentially, this so-called Red Button feature provides the unique process of allowing the client the opportunity to address any potential problems that a customer has before that customer posts a negative review. This basically includes the client creating an account, the system providing the client with materials to provide access to customer online review, displaying the option to the customer of leaving a review on a typical review site or, if the customer has any issues, to contact the client and/or the system before leaving any review so that the issue can be addressed. This, more often than not, will result in an eventual positive review being posted.

Third, an accreditation process will be described. This is an important feature for the system and method for managing customer feedback as it provides the ability to monitor online reputation. This is done by gathering online reviews of all available sources (starting with the current top sources) and providing companies (clients) with a score, a so-called Trust Online Score. This process is illustrated with a simplified logic diagram of FIG. 9.

Referring now thereto, the client starts with navigating to the get accredited page 178 and then the prequalification calculator 180 determines whether the client is approved. If approved, the system then determines 182 whether such approval is instant or conditional 184. If conditional, the system will contact the client to help complete the process towards approval. Guidelines for accreditation approval are part of the platform internal processes, but may include, for example, business validation, reputation above 4.5 star average, review response rate above 80%, total reviews above 500, location and listing validations, etc. In any event, upon approval, the client enters their payment information, selects the amount of locations to be added, creates an account on the mobile app; and the system sends a welcome package including, for example, badge (window) stickers, table stands, digital signage, maintenance guidelines, whitepaper, etc., and the “Accredited Business” label is added to the client online presence 186. This package helps the client to direct their customers to leave reviews using the subject platform.

Turning back to the prequalification calculator 180, if the client is not approved, the system will help 188 the client increase their online reviews and reputation. The client enters their payment information to activate their account and the system sends a welcome package and displays the current accreditation status 190. A progress bar 192 is continuously updated and once achieved, the system offers accreditation.

This progress bar 192 is illustrated in a PCD screenshot of FIG. 10. As the client accreditation progresses, the bar 194 fills and may even change colors. For example, red—not eligible to yellow—almost there to green—ready to go. Marketing material status 196 may be dependent upon overall progress. Again, the guidelines for accreditation may include business validation 198, location(s) validation 200, and listing validation 202. Further guidelines may further also include current status. For example, reputation 204, review response rate 206 and total reviews 208.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A system for managing online customer reviews, the system comprising:
a system server;
at least one client PCD communicatively coupled to said server through a network;
at least one customer PCD communicatively coupled to said server through said network;
a system tool running on said server for managing online reviews from a customer of a client; and
said tool displaying a review page on said customer PCD wherein said page includes one or more review options and a non-review option.

2. The system as defined in claim 1 wherein said non-review option is red in color.

3. The system as defined in claim 1 wherein said non-review option prompts said customer to make contact.

4. The system as defined in claim 3 wherein said system contacts said customer.

5. The system as defined in claim 3 wherein said client contacts said customer.

6. The system as defined in claim 1 wherein said review page is customizable by said client.

7. A method for managing online customer reviews, the method consisting of:
creating a client account with a review management system;
providing a customer of said client access to a system review page; and
displaying options on said review page to said customer wherein said options include one or more review options and a non-review option.

8. The method as defined in claim 7 further consisting of authenticating said client account.

9. The method as defined in claim 7 further consisting of displaying said non-review option in red color.

10. The method as defined in claim 7 further consisting of prompting said customer to make contact when selecting said non-review option.

11. The method device as defined in claim 10 further consisting of contacting the customer from said system.

12. The method as defined in claim 10 further consisting of contacting said customer from said client.
